(19) United States
(12) Patent Application Publication
(10) Pub. No.: US 2022/0379270 A1
(43) Pub. Date: Dec. 1, 2022

(54) HYDROPHOBIC MFI ZEOLITE HOLLOW FIBER MEMBRANES

(71) Applicants: Jerry Lin, Scottsdale, AZ (US); Seyed Mojtaba Mirfendereski, Houston, TX (US)

(72) Inventors: Jerry Lin, Scottsdale, AZ (US); Seyed Mojtaba Mirfendereski, Houston, TX (US)

(21) Appl. No.: 17/741,616

(22) Filed: May 11, 2022

Related U.S. Application Data
(60) Provisional application No. 63/188,774, filed on May 14, 2021.

(51) Int. Cl. B01D 71/02

(52) U.S. Cl. CPC B01D 71/028; B01D 2325/02; B01D 2325/38

(57) ABSTRACT

Fabricating a zeolite membrane on a substrate includes disposing first zeolite crystals on a substrate to yield a first layer on the substrate and disposing second zeolite crystals on the first layer to yield a second layer on the first layer, thereby yielding a membrane precursor. The membrane precursor is heated at a first temperature for a first length of time, and the temperature of the membrane precursor is increased or decreased from the first temperature to a second temperature. The membrane precursor is heated at the second temperature for a second length of time to yield the zeolite membrane. The second zeolite crystals have a smaller average diameter than the first zeolite crystals. The second temperature can exceed the first temperature or the first temperature can exceed the second temperature.

### CROSS-REFERENCE TO RELATED APPLICATION

This application claims the benefit of U.S. Patent Application 63/188,774 filed on May 14, 2021, which is incorporated herein by reference in its entirety.

### TECHNICAL FIELD

This invention relates to MFI zeolite (silicalite) hollow fiber membranes.

### BACKGROUND

Hydrophobic MFI zeolite (silicalite) membranes demonstrate chemical stability, unique frameworks, and intermediate pore sizes. They are perm-selective to organic compounds over water and can be used for separations of water and organic compounds.

### SUMMARY

Synthesis of hydrophobic MFI zeolite membranes on alumina hollow fiber supports is described. Methods disclosed include dual-layer seeding and varying-temperature, time, or both time and temperature of secondary growth. The microstructure of membranes can be manipulated by the dual-layers of large crystals on bottom and small crystals on top, which yields membranes with increased selectivity in the separation of water and organic compounds without sacrificing the permeance. Secondary growth under the conditions of variable temperature reduced or eliminates the inter-crystalline gaps, defects, or both with balanced nucleation and grow reaction rates. This dual-layer seeding with varying temperature secondary growth also produces MFI zeolite membranes with high hydrophobicity by the elimination of direct and indirect aluminum transport from support to the zeolite framework. The hydrophobic MFI zeolite membranes demonstrate enhanced performance of separations of water and organic compounds with respect to selectivity and permeance.

Identification of optimum crystal structure and secondary growth conditions for synthesis of MFI zeolite membranes with separation capabilities of water and organic compounds (e.g., microstructure, hydrophobicity and gas perm-selectivity of the membranes) are described as a function of seeding method, crystal size, crystal size ratio, and variable temperature profile, time profile, or both. The MFI zeolite membranes have a microstructure including a thin, fully inter-grown, and dense top zeolite layer responsible at least in part for high selectivity, and a porous low inter-grown bottom zeolite layer minimizing resistance and retarding aluminum transfer from the support to zeolite.

In a first general aspect, fabricating a zeolite membrane on a substrate includes disposing first zeolite crystals on a substrate to yield a first layer on the substrate and disposing second zeolite crystals on the first layer to yield a second layer on the first layer, thereby yielding a membrane precursor. The first general aspect further includes heating the membrane precursor at a first temperature for a first length of time, increasing or decreasing the temperature of the membrane precursor from the first temperature to a second temperature, and heating the membrane precursor at the second temperature for a second length of time to yield the zeolite membrane. The second zeolite crystals have a smaller average diameter than the first zeolite crystals. The second temperature can exceed the first temperature or the first temperature can exceed the second temperature.

Implementations of the first general aspect can include one or more of the following features.

The zeolite membrane can be an MFI zeolite membrane. The substrate can include a hollow fiber. The hollow fiber can include alumina. In some cases, the zeolite membrane is substantially free of intercrystalline gaps. Disposing the second zeolite crystals on the first layer can include filling gaps between the first zeolite crystals with the second zeolite crystals.

In some implementations, the first zeolite crystals have an average diameter in a range of 0.5 μm to 2.0 μm. In some cases, the second zeolite crystals have an average diameter in a range of 50 nm to 500 nm.

The first temperature can be in a range of 110° C. to 140° C. In some cases, the second temperature is in a range of 150° C. to 190° C.

The first length of time can be in a range of 1 hour to 10 hours. The second length of time can be in a range of 1 hour to 10 hours.

In certain implementations, the zeolite is silicalite. The molar ratio of Si to Al typically exceeds 150. The zeolite membrane can be hydrophobic.

In a second general aspect, a zeolite membrane includes a substrate, a first zeolite layer on the substrate, and a second zeolite layer on the first zeolite layer. A porosity of the first zeolite layer exceeds a porosity of the second zeolite layer.

Implementations of the second general aspect can include one or more of the following features.

The substrate can include a hollow fiber. In some cases, the hollow fiber includes alumina (e.g., silicalite). The first zeolite layer can include first intergrown zeolite crystals, and the second zeolite layer can include second intergrown zeolite crystals. In some implementations, the zeolite membrane is hydrophobic.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic diagram depicting hybrid synthesis of hydrophobic MFI zeolite membranes on alumina hollow fiber supports.

FIGS. 2A and 2B are scanning electron microscopy (SEM) images of a transverse cross section and surface, respectively, of a hollow fiber α-alumina support. FIGS. 2C and 2D are SEM images of the surface and cross-section, respectively, of a two-layer MFI zeolite membrane coated on the outer surface of a hollow fiber α-alumina support. FIG. 2E is a magnified view of a two-layer MFI zeolite membrane.

FIG. 3 depicts a pervaporation system.

FIGS. 4A and 4B show pervaporation separation factor versus the flux of separation of ethanol and water and methanol and water, respectively, for MFI zeolite membranes.

### DETAILED DESCRIPTION

Pure-silica MFI-type zeolite membranes exhibit strong hydrophobicity. The hydrophobicity of MFI zeolite is controlled at least in part by the molar ratio of Si to Al of the zeolite framework. Pure silica MFI zeolite (silicalite) are hydrophobic, and such hydrophobic MFI zeolite membranes are perm-selective to organic compounds over water. MFI zeolite membranes synthesized on conventional supports (alumina or mullite) are typically contaminated by aluminum ions due at least in part to the support leaching during secondary growth or solid-state diffusion during calcination.

Selectivity between water and organic compounds can be compromised by the presence of defects and non-zeolitic pores in zeolite membranes with transport by less selective Knudsen diffusion or non-selective viscous flow. The seeding procedure and the quality and density of the seed layer impact the quality of the final MFI zeolite membrane layer and also affect aluminum leaching, potentially lowering the hydrophobicity of the MFI zeolite membranes and reducing the selectivity between water and organic compounds. Defects in the zeolite membranes can be formed as a result of defects on the support or mismatch in the crystal volume change with respect to support due to heating and cooling cycles in the template removal process.

This disclosure describes synthesis of MFI-type zeolite membranes to minimize defects and aluminum content of membrane layer. Methods include dual-layer zeolite crystal seeding in combination with varying-temperature secondary growth to yield hydrophobic, defect-free MFI zeolite membranes on alumina hollow fiber supports.

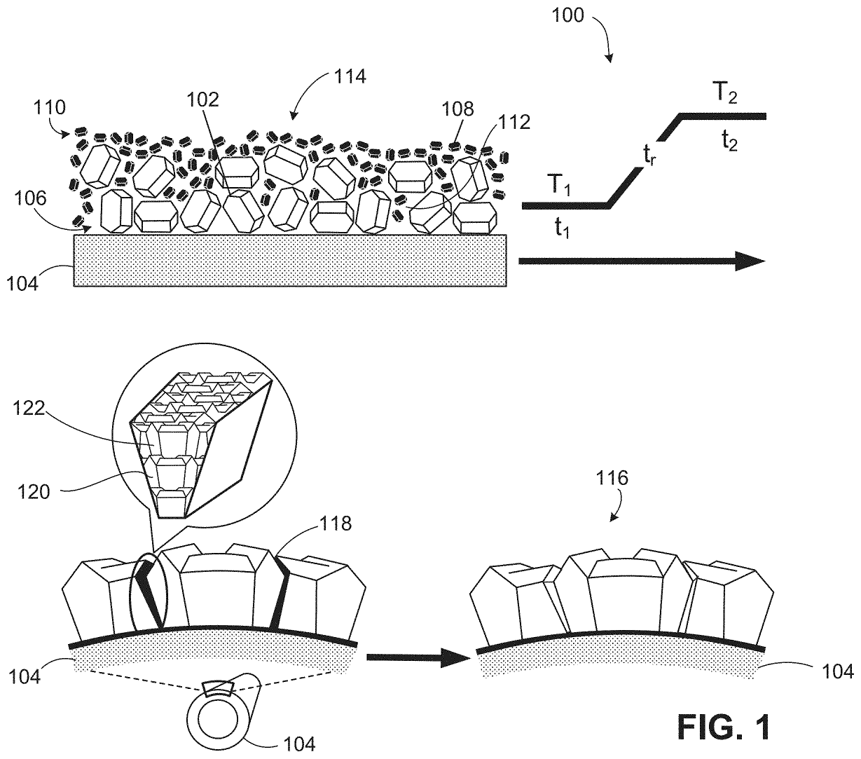

FIG. 1 depicts a dual layer zeolite crystal seeding process 100. Fabricating a zeolite membrane on a substrate includes disposing first zeolite crystals 102 on a substrate 104 (e.g., a alumina hollow fiber) to yield a first zeolite layer 106 on the substrate, and disposing second zeolite crystals 108 on the first layer 106 to form a second zeolite layer 110 on the first zeolite layer 106. The second zeolite crystals 108 have a smaller average diameter than the first zeolite crystals 102, such that disposing the second zeolite crystals 108 on the first zeolite layer 106 includes filling gaps 112 between the first zeolite crystals 102 with the second zeolite crystals 108. The substrate 104 with the first zeolite layer 106 and the second zeolite layer 110 is referred to as a membrane precursor 114.

The membrane precursor 114 is heated at a first temperature T₁ (e.g., in a range of 110° C. to 140° C.) for first length of time t₁ (e.g., 1 to 5 hours). The temperature of the membrane precursor 114 is then increased or decreased over time tᵣ to a second temperature T₂ that is greater than or less than the first temperature. The membrane precursor 114 is then heated at the second temperature for a second length of time t₂ (e.g., 1 to 5 hours) to yield the zeolite membrane 116. In some examples, T₁ is in a range of 110° C. to 140° C. (e.g., 125° C.) and the second temperature is in a range of 150° C. to 190° C. (175° C.). In another example, first temperature is 175° C. and the second temperature is 125° C. The variable temperature profiles facilitate control of the nucleation and growth reaction rates, resulting in an improvement in membrane selectivity by the elimination of inter-crystalline gaps 118 and an increase in the hydrophobicity of the zeolite membrane 116.

As described herein, a zeolite membrane 116 includes a substrate 104, a first zeolite layer 106 on the substrate 104, and a second zeolite layer 110 on the first zeolite layer 106. The zeolite membrane 116 is an WI zeolite membrane. The zeolite membrane 116 is substantially free of inter-crystalline gaps, and is hydrophobic.

The first zeolite crystals 102 have an average diameter in a range of 0.5 μm to 2.0 μm, and the second zeolite crystals 108 have an average diameter in a range of 0.05 μm to 0.4 μm. As used herein, “particle size” refers an average diameter of a multiplicity of zeolite crystals. As used herein, a “zeolite crystal” is an individual single particle, not an agglomeration of two or more particles. In some embodiments, a zeolite crystal can be visually identified by microscopy and distinguished from agglomerations of two or more zeolite crystals based on size, shape, or both.

Gaps 112 between the first zeolite crystals 102 are filled with the second zeolite crystals 108. A porosity of the first zeolite layer 106 exceeds a porosity of the second zeolite layer 110. The first zeolite layer 106 has first intergrown zeolite crystals 120, and the second zeolite layer 110 has second intergrown zeolite crystals 122. In some cases, the substrate 104 is a hollow fiber. In one example, the zeolite includes silicalite (e.g., with a molar ratio of Si:Al>150), and the hollow fiber is composed of alumina.

### Examples

### Preparation of Zeolite MFI Crystals

The multilayer seeding technique described herein uses zeolite crystals with different particle sizes produced by different procedures. Coffin-shape zeolite MFI crystals with average diameters of 600 nm, 1.0 μm, and 1.5 μm were prepared from synthesis mixture with the molar composition of 4 SiO₂:tetrapropylammonium hydroxide (TPAOH): 1000 H₂O by adding fumed silica (Sigma-Aldrich, 7 nm, 350-440 m² g⁻¹) and sodium hydroxide (Sigma-Aldrich, 98%) in TPAOH (Sigma-Aldrich, 1 M) solution. The mixture was aged under stirring at room temperature for 24 h until a clear homogeneous solution was obtained. The crystal sizes were controlled though adjustment of the synthesis time program during the synthesis. The 100 nm and 400 nm sphere-shape crystals were prepared from the mixture of the same precursors with the molar composition of 10 SiO₂: 2.5 TPAOH: 0.8 NaOH: 110 H₂O. The crystal sizes were controlled by adjustment of the synthesis time during the synthesis. The solution was then transferred to a Teflon-lined stainless steel autoclave and placed in an oven set at 125° C. After appropriate synthesis time (8 h, 5 h, 6 h, 10 h, and 14 h for 100 nm, 400 nm, 600 nm, 1.0 μm, and 1.5 μm crystals, respectively), the obtained zeolite crystals were purified by repeated rinsing and centrifuging processes.

### Synthesis of MFI Membranes on Alumina Hollow Fiber Supports

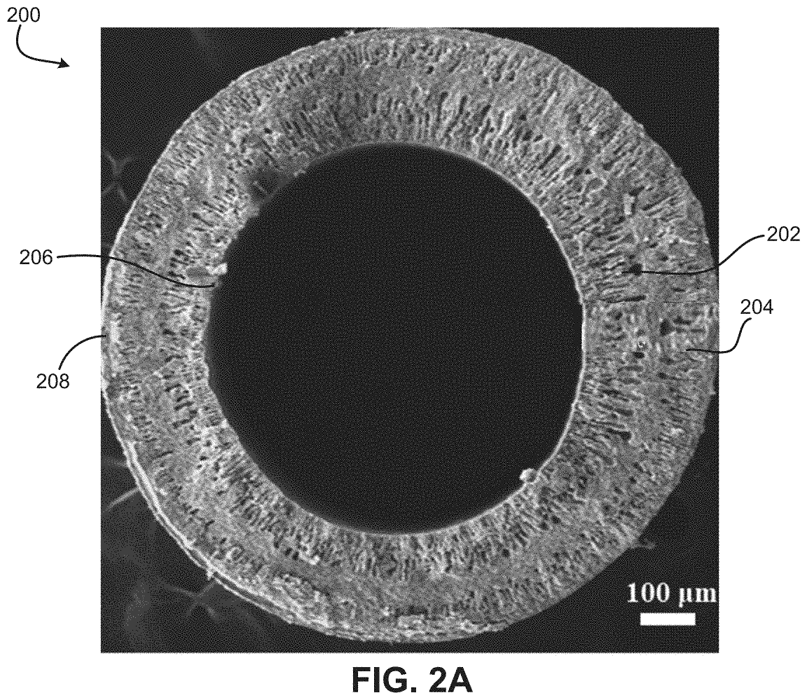

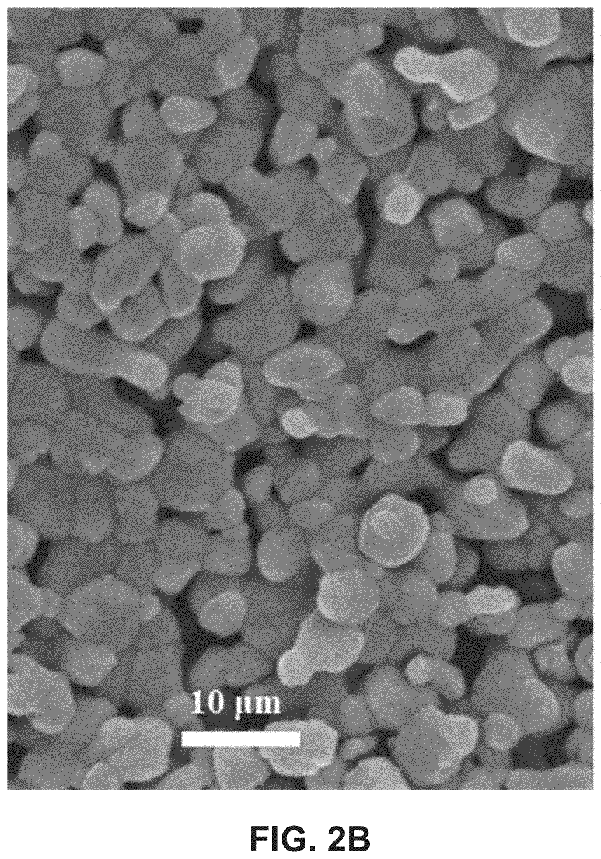

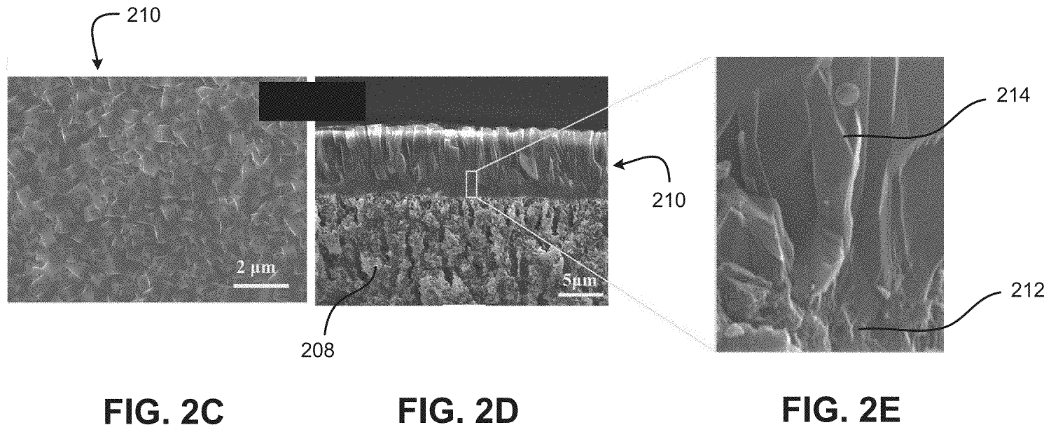

Alumina hollow fiber supports were prepared by a phase-inversion spinning method. Table 1 lists specifications of the alumina porous hollow fiber, and FIGS. 2A and 2B are scanning electron microscopy (SEM) images of a transverse cross-section and the outer surface, respectively, of the hollow fiber alumina support 200. The finger-shaped, micron-sized cavities 202, 204 near the inner surface 206 and the outer surface 208, respectively, of the α-alumina hollow fiber wall are evident in FIG. 2A. This structure provides mechanical strength without increasing the mass transfer resistance. The average pore size of the substrates was determined by mercury porosimetry. Both ends of alumina hollow fiber substrates were sealed by a glazing method before being used for coating zeolite membranes.

TABLE 1
Specifications of used alumina hollow fiber support

| | | Wall | | Curvature | | average |
|---|---|---|---|---|---|---|
| | O.D | thickness | Length | (K) | Porosity | pore |
| Support | (mm) | (mm) | (mm) | (mm⁻¹) | (%) | size (μm) |
| α-alumina | 1.3 | 0.2 | 50 | 1.54 | 56 | 0.2 |

FIG. 2B shows a magnified view of the outer surface of the hollow fiber alumina support. FIGS. 2C and 2D are SEM images of the surface and cross-section, respectively, of a two-layer MFI zeolite membrane 210 coated on the outer surface 208 of a hollow fiber α-alumina support 200. FIG. 2E shows porous bottom layer 212 and dense top layer 214 of two-layer MFI zeolite membrane 210. Two layers of MFI zeolite crystals were coated on the outer surface of the hollow fiber support using the dip-coating technique. The first layer has large crystals (1.5 μm, 1.0 μm, and 600 nm), and the second layer has small crystals (400 nm and 100 nm). These layers were coated on the support using crystal suspensions prepared by mixing 2-5 g of MFI crystals of specific particle size, 0.14 g hydroxypropyl cellulose solution (Sigma-Aldrich, 0.5 wt. % HPC, MW=100 000 g mol⁻¹) as a binder and 94 mL DI water, followed by reducing the pH of the solution to 3 by adding a few drops of 1 M HNO₃. The hollow fiber supports were dip-coated with the crystal suspension for 5-7 s and were then dried for 24 h under controlled humidity (40%) and temperature (40° C.). The dried seeded supports were then calcined at 450° C. for 8 h and subsequently at 650° C. for 8 h with heating and cooling rates of 20° C. h⁻¹. The above-mentioned procedure was repeated up to three times using crystals with different particle sizes according to Table 2. To avoid the negative effects of the possible difference in content and thickness of the crystal layer on the membrane growth, the same seeding procedure was used for all samples. The synthesis procedure was repeated three times for all membranes to confirm reproducibility. The ultimate thicknesses of the prepared membranes were in a limited range, confirming approximately the same thickness of the crystal layers for all samples.

TABLE 2
MFI zeolite membranes prepared with different crystal size ratio*

| | | | | | | |
|---|---|---|---|---|---|---|
| | | Crystal | Final | | | |
| | Top/Bottom | size | membrane | | | |
| | layer crystal | ratio | thickness | N₂ permeance | SF₆ Permeance | N₂/SF₆ Ideal |
| Sample | size (nm) | (CSR) | (μm) | (mol m⁻²s⁻¹Pa⁻¹) | (mol m⁻²s⁻¹Pa⁻¹) | Selectivity |

Series 1: Single-layer seeding (SLS)

| | | | | | | |
|---|---|---|---|---|---|---|
| M1 | 1500 | — | ~3 | 3.20 × 10⁻⁵ | 1.27 × 10⁻⁵ | 2.52 |
| M2 | 600 | — | ~3 | 2.30 × 10⁻⁵ | 6.85 × 10⁻⁶ | 3.36 |
| M3 | 100 | — | ~5 | 2.10 × 10⁻⁵ | 2.50 × 10⁻⁶ | 8.4 |

Series II: Dual-layer seeding (DLS), Varying small crystals at the top

| | | | | | | |
|---|---|---|---|---|---|---|
| M4 | 1500/1500 | 1 | ~5 | 2.10 × 10⁻⁵ | 3.33 × 10⁻⁶ | 6.3 |
| M5 | 1000/1500 | 1.5 | ~6 | 1.60 × 10⁻⁵ | 7.37 × 10⁻⁷ | 21.7 |
| M6 | 600/1500 | 2.5 | ~9 | 1.10 × 10⁻⁵ | 2.91 × 10⁻⁷ | 37.8 |
| M7 | 400/1500 | 3.75 | ~11 | 9.00 × 10⁻⁶ | 2.18 × 10⁻⁷ | 41.2 |
| M8** | 100/1500 | 15 | ~12 | 6.10 × 10⁻⁶ | 1.07 × 10⁻⁷ | 57.2 |

Series III: Dual-layer seeding (DLS), Varying large crystals at the bottom

| | | | | | | |
|---|---|---|---|---|---|---|
| M9 | 100/1000 | 10 | ~12 | 3.40 × 10⁻⁶ | 2.82 × 10⁻⁸ | 120.4 |
| M10 | 100/600 | 6 | ~14 | 1.68 × 10⁻⁶ | 9.68 × 10⁻⁹ | 173.5 |
| M11 | 100/400 | 4 | ~14 | 5.40 × 10⁻⁷ | 2.81 × 10⁻⁹ | 192.5 |
| M12 | 100/100 | 1 | ~15 | 1.00 × 10⁻⁷ | 4.93 × 10⁻¹⁰ | 203 |

*All membranes were synthesized at a constant temperature of 175° C.
**Sample M8 is shared by Series III

For secondary growth, zeolite synthesis solution with molar composition of 0.9 NaOH: 0.9 TPABr: 4 SiO₂: 1000 H₂O: 16 EtOH was prepared by dissolving sodium hydroxide, tetrapropylammonium bromide (Sigma-Aldrich, TPABr), and ethanol in deionized (DI) water, heating under reflux up to 80° C., and the gradual addition of fume silica powder under vigorous stirring until a clear solution obtained. The mixture was aged under reflux at 80° C. for 6 h. The aged solution was cooled down and transferred into a Teflon-lined stainless-steel autoclave in which the MFI zeolite seeded hollow fiber substrate was positioned horizontally (to promote the growth of MFI zeolite membrane of uniform thickness) in the center using a bicuspid Teflon holder. The secondary growth synthesis of the MFI membranes was conducted at three different synthesis temperature-time profiles. For constant temperature (CT) profile, the oven was preheated to a given temperature (e.g. 175° C.), and the autoclave was placed in the oven, kept at the constant temperature for 8 h. For rapid varying-temperature profiles, the autoclave was taken out after 4 h synthesis at initial temperature and immediately transferred to another preheated oven (e.g. 125° C.) for the remaining 4 h synthesis. For gradually variable temperature profiles, the temperature of the oven was varied in a controlled manner with a specific temperature profile. The hydrothermally-treated membranes were rinsed, dried overnight at controlled humidity and temperature (40% and 40° C., respectively), and then calcined at 450° C. for 8 h with a heating and cooling rate of 20° C./h to remove the organic compounds.

### Characterization and Gas/Vapor Permeation/Separation Tests

The phase structure of the MFI crystals and membranes on hollow fiber supports was examined by X-ray diffraction (XRD, Bruker AXS-D8, Cu Kα radiation, λ=1.5406 Å). The cross-section and surface morphology of MFI membranes, α-alumina hollow fiber supports, and MFI crystals were evaluated using SEM (Amray 1910). The molar ratio of Si to Al of the zeolite layer was measured by energy-dispersive X-ray spectroscopy (EDX, Amray 1910). The surface hydrophobicity was determined by contact angle measurement (DropMeter A-100p) using sessile drop mode with a 0.5 mL droplet of deionized water.

In gas permeation/separation tests, an MFI hollow fiber zeolite membrane was mounted into a stainless-steel dead-end membrane module. Single-gas (N₂, and SF₆) permeation experiments were performed. The gas permeation tests were studied at 25° C. and a transmembrane pressure range of 100-300 kPa. The permeation flow rate was measured by a bubble flow meter. The gas permeances were calculated by Eq. 1,

$${P}_{i} = \frac{{Q}_{i}}{A ( {p}_{f} - {p}_{p} )} \qquad ( 1 )$$

where Pᵢ is the permeance of species i (mol m⁻² s⁻¹ Pa⁻¹); Qᵢ is the gas flow rate at the permeate side (mol s⁻¹), pᵣ and pₚ are the feed and permeate pressures (Pa); and A is the active membrane area (m²), used to obtain the ideal selectivity (the ratio of pure gas permeance N₂ and SF₆) to examine membrane quality. The reported gas permeation data were the mean values of multiple measurements.

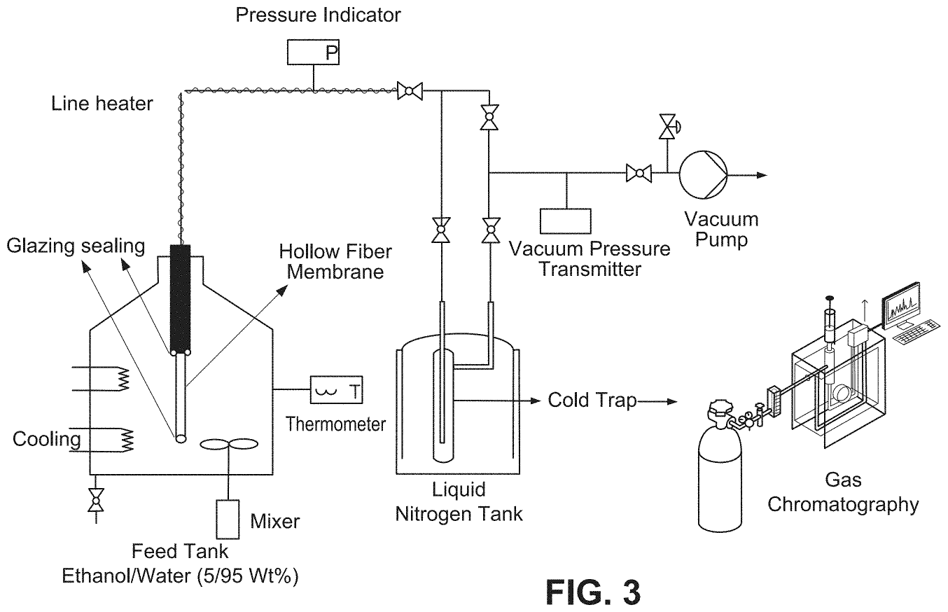

The pervaporation tests for separation of separation of ethanol and water were conducted with a mixture of 5 wt % ethanol in the water at 25° C. in a pervaporation setup, as shown in FIG. 3. The membranes were sealed vertically in a stainless-steel vessel, and the liquid feed mixture was contacted with the MFI zeolite layer. The permeate side was evacuated using a strong vacuum pump, and the permeate vapors were collected in the cold trap which was weighted before and after the tests in order to flux measurement. Permeate and feed compositions were analyzed using gas chromatography (Agilent, 7890A) (FID detector, with column of J&W DB-FATWAX Ultra Inert, 30 m×0.25 mm, 0.25 μm). The flux (J) and the separation factor (α) of membrane pervaporation were calculated by the Eq. 2 and Eq. 3,

$$J = \frac{m}{A t} \qquad ( 2 )$$

$$α = \frac{{y}_{alcohol} / {y}_{water}}{{x}_{alcohol} / {x}_{water}} \qquad ( 3 )$$

where m is the mass of the collected permeate (kg), t is the duration of the experiments (h), x and y are the molar fractions of feed and permeate, respectively.

### Effects of Crystal Layer on Membrane Performance

MFI zeolite crystals of different size were synthesized by controlling hydrothermal synthesis duration. The small MFI crystals (100 nm and 400 nm) had a sphere-shape and the large crystals (600 nm, 1 μm, and 1.5 μm) had a coffin shape. The sphere-shape of the small crystals, when used for the top crystal-layer, facilitates their penetration into the gaps/defects between the large coffin-shaped crystals in the bottom layer. Moreover, sphere-shaped crystals, unlike coffin-shaped ones, grow isotropically which favors the filling of inter-crystalline gaps in the bottom layer. The XRD patterns of the synthesized MFI zeolite crystals (ca. 100 nm, 400 nm, 600 nm, 1 μm, and 1.5 μm) include the characteristic peaks of MFI-type zeolite and are pure crystalline. The intensity of characteristic XRD peaks increase with increasing crystal size. MFI zeolite membranes were grown on the alumina hollow fiber supports with the layers in three different arrangements, as show in Table 2. The first arrangement is the single-layer seeding using zeolite particles of different size (Series I). The second and third arrangements are the two-layer seeding Series of zeolite crystals of different size for each layer, which are further divided into bottom-layer of fixed crystal size (Series II) and top-layer of fixed crystal size (Series III). In Series II and III, one parameter is the crystal size ratio (CSR) defined by Eq. 4,

$$C S R = \frac{Size of Large Crystals ( Bottom Layer )}{Size of Small Crystals ( Top Layer )} \qquad ( 4 )$$

which is also listed in Table 2. All the hollow fiber supports after seeding were subjected to secondary growth at the constant temperature conditions at 175° C. for 8 hr and then characterized for morphology/phase-structure and gas permeance/selectivity.

The membrane thickness of three typical membranes of Series I, II, and III was estimated from SEM images and is reported in Table 2. The data in Table 2 show the thickness of single-layer seeded membranes increases with decreasing crystal size. The data also show that the thickness of the membranes with varying crystals at the top layer (Series II) is influenced by the CSR, while the thickness of those membranes with varying crystals at the bottom later (Series III) does not vary considerably with CSR. This is attributed at least in part to large crystals on the top-layer that are loosely packed with larger gaps and hence lower space limitation suppression. This allows large crystals to grow in different directions with a slower rate than that of small crystals. The small crystals, due to their lower inter-crystalline gaps, mainly grow in the direction perpendicular to the support surface resulting in a thicker zeolite layer. It can be concluded that the crystal size at the top layer determines the final thickness of the membrane.

SEM images show that the membranes in Series III have a smoother and more uniform surface than those in Series II and I. It is observed that the smaller crystal at the top layer, the more uniform and continuous the membrane surface. Intergrowth of the penetrated small crystals from the top layer into the inter-particle space of the bottom layer densifies the entire zeolite layer, improving the overall quality of the membranes. The hollow fiber supported zeolite membranes synthesized with crystal layers of different arrangements exhibit XRD patterns of MFI zeolite structure; however, with different peak intensity. The XRD patterns show that these membranes contain pure MFI phase and are randomly-oriented.

The quality of MFI membranes was evaluated by N₂ and SF₆ pure gas permeation at ambient temperature. Because of the difference in the kinetic diameter for N₂ (0.36 nm) and SF₆ (0.55 nm), N₂ permeance and ideal selectivity between N₂ and SF₆ can be an indicator of membrane quality. The permeance and ideal selectivity of all the synthesized membranes are also listed in Table 2. As shown in Table 2, MFI zeolite membranes with one-layer crystals have lower ideal selectivity between N₂ and SF₆ than membranes with two-layer crystals, confirming the presence of defects for those one-layer seeded MFI zeolite membranes. Membranes with two-layer crystals, especially the Series III with the bottom layer of crystals of smaller particles, show higher selectivity. This shows the effectiveness of two-layer seeding on improving the quality of the final MFI zeolite membranes.

Data in Table 2 also show that the CSR (Eq. 4) affects the performance of two-layer seeded MFI zeolite membranes (Series II and III). Plots of permeance and ideal selectivity between N₂ and SF₆ versus CSR for Series II and Series III membranes show that the permeance of membranes in Series II decreases slightly with increasing CSR. Considering that Series II membranes were synthesized by variable crystal size at the top layer, the results of these plots reveal that the crystal size at the bottom layer mainly controls the membrane permeance.

Plots of permeance and ideal selectivity between N₂ and SF₆ versus CSR for Series II and Series III membranes 6B also confirm that varying the crystal size in the bottom layer (in Series III membranes) affects the membrane permeance. For example, replacing the 1.0 μm crystals by 100 nm crystals in the bottom layer, when the crystal size in the top layer remains the same at 100 nm, decreases N₂ and SF₆ permeances by 97% and 98% respectively, resulting in a 190% increase in the ideal selectivity. The corresponding values for Series II membranes (which obtained from replacing the 1.0 μm crystals by 100 nm crystals in the top layer) are 60%, 85%, and 260% for N₂ and SF₆ permeances and selectivity, respectively.

Increasing the crystal size in the bottom layer from 100 nm to 600 nm in Series III membranes increases the permeance by 16.8 times. It is possible that using larger crystals in the bottom layer (larger than the pore size of the support) decreases the penetration of crystals into the support pores resulting in a reduction in effective membrane thickness and mass transfer resistance. However, a further increase in bottom crystal size from 1.0 to 1.5 μm increases the permeance by only 1.8 times, which could be related to the formation of more inter-crystalline gaps and non-zeolitic pores in the bottom layer. Thus when the crystals in the bottom layer are large enough to prevent the crystals from penetrating into the support pores, a further increase in the crystal size will only increase the membrane permeance to some extent due to larger the inter-particle space of the crystal-layer.

During the dual-layer seeding process, small crystals from the top layer penetrate into the inter-particle space of the bottom crystal layer. Because of their higher growth rate compared to the large crystals, small crystals effectively fill the gaps/defects during the hydrothermal synthesis, resulting in membranes (Series III) of higher quality as compared to membranes with top layer of larger crystals (Series II). A reduction in the crystal size in the bottom layer with top-layer of constant crystal size facilitates filling of the inter-particle space of the bottom-layer and growth of zeolite layer, resulting in a membrane with less inter-crystalline gaps and larger thickness. This enhances selectivity and decreases permeance of the membranes.

A plot of ideal selectivity between N₂ and SF₆ versus N₂ permeance for Series II and Series III membranes shows that Series II and III membranes respectively locate in high permeance/low selectivity, and high selectivity/low permeance regions. Crystal size change at the top layer primarily influences the membrane selectivity, while crystal size change at the bottom layer primarily influences the membrane permeance. The M10 membrane (from Series III) has the best crystal-layer structure (100 nm for top-layer and 600 nm for bottom-layer). Thus, the alumina hollow fiber supports with such dual-layer crystal coating were used for secondary growth under variable-temperature conditions to further optimize membrane quality and separation characteristics.

### Secondary Growth of MFI Zeolite Membranes

Growth of zeolite crystal layers into continuous zeolite membranes can be controlled by the structure of crystal layer and secondary synthesis conditions such as composition of the synthesis solution, temperature and time. Because nucleation and crystal growth are respectively favored at low and high temperatures, tests on secondary growth of the best seeded hollow fiber supports (Sample M10) under the following five different temperature profiles were conducted in order to identify optimum conditions for obtaining high-quality MFI zeolite membranes:

(i) Constant Temperature (CT);

(ii) Varying temperature from low to high rapidly (VT-LH);

(iii) Varying temperature from low to high gradually (VT-LsH);

(iv) Varying temperature from high to low rapidly (VT-HL);

(v) Varying temperature from high to low gradually (VT-HsL

Table 3 summarizes synthesis conditions for the secondary growth and performances of membranes. The SEM and XRD data of these secondary grown membranes show high crystallinity of the MFI monolayer formed on the surface of hollow fiber alumina supports. The average crystallite sizes, estimated using a morphological determination method, are given in Table 3. Membranes M14 and M13 exhibited more uniform and continuously intergrown polycrystalline films of MFI crystals. The microstructure of the M14 membrane was slightly different from M13 membrane, in which lower intergrown polycrystalline microstructure, larger surface roughness and some small macro-pores on the surface can be observed. The membranes synthesized at lower initial temperatures (M13 and M14) had a thinner zeolite layer which can be ascribed at least in part to the domination of nucleation reactions at the low temperature of 125° C.

TABLE 3
Effect of using the varying-temperature methods on membrane M10 (prepared using dual-
layer seeding method by 600 nm and 100 nm crystals as bottom and top layers, respectively.

| | | | N₂ | SF₆ | N₂/SF₆ | | Appx. |
|---|---|---|---|---|---|---|---|
| | Temp | | permeance | Permeance | ideal | | crystal |
| Sam- | profile | Temperature | (mol m⁻²s⁻ | (mol m⁻²s⁻ | selec- | Membrane | diameter |
| ple | code | profile | ¹Pa⁻¹) | ¹Pa⁻¹) | tivity | thickness | (nm) |
| M13 | VT-LH | 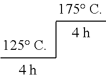 | 1.35 × 10⁻⁶ | 1.30 × 10⁻⁸ | 103.5 | ~4 | 400 |
| M14 | VT-LsH* | 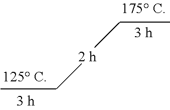 | 1.01 × 10⁻⁶ | 6.24 × 10⁻⁹ | 162.2 | ~4 | 500 |
| M15 | VT-HsL* | 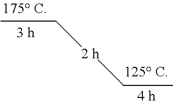 | 1.14 × 10⁻⁶ | 1.21 × 10⁻⁸ | 94.8 | ~5 | 800 |
| M16 | VT-HL | 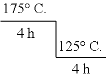 | 8.97 × 10⁻⁷ | 7.23 × 10⁻⁹ | 124.1 | ~6 | 900 |
| M10 | CT | 175° C. | 1.68 × 10⁻⁶ | 9.68 × 10⁻⁹ | 173.5 | ~14 | 1500 |

*refers to change in temperature over time with a slope

The zeolite nuclei formed in the secondary growth at the initial low temperature (125° C.) stage in membranes M13 and M14 can penetrate into the spaces between fixed zeolite crystals both in the top layer and in the bottom layer. Their higher growth rate compared to that of larger crystals at the high temperature (175° C.) stage effectively fills the non-zeolitic pores and defects resulting in a dense and uniform zeolite layer. A comparison of SEM images of M13 and M14 shows that the gradual increase in temperature might result in a membrane with a more continuous and uniform microstructure. The membranes (M15 and M16) synthesized at high starting temperature (175° C.) show thicker zeolite layer and rougher surface due to the domination of crystal growth over the nucleation at the initial stage. Unlike what is observed in synthesized samples with low initial temperatures, a rapid decrease in temperature shows better results than a gradual decrease for the synthesized membranes at high initial temperatures due to the longer exposure at high temperature.

XRD data show that the crystallinity increases in the order of M13˜M14<M15<M16<M10. Starting the synthesis at low temperature favors the nucleation over the crystal growth, which produces a larger number of smaller crystals. After the initial low temperature period, increasing temperature immediately (M13) or gradually (M14) shifts the dominant reaction from nucleation to crystal growth. At the end of synthesis, a large number of mid-size crystals are formed. Such temperature profiles may also reduce the thickness of the zeolite layer. However, they lead to a more integrated and uniform layer with reduced inter-crystalline gaps. The results also show that for a constant total synthesis time, secondary growth at a higher temperature for a longer period of time produces zeolite membranes with higher crystallinity, larger thickness and less inter-crystalline gaps.

The N₂ and SF₆ permeances and ideal selectivity between N₂ and SF₆ of all the synthesized membranes are also listed in Table 3. As shown, MFI zeolite membranes synthesized at low initial temperature (175° C.) have higher ideal selectivity between N₂ and SF₆ than those synthesized at a high initial temperature, confirming the effectiveness of nucleation reactions on improving the selectivity of the final MFI zeolite membranes. Data in Table 3 also show that a high initial synthesis temperature leads to the formation of fewer but larger crystals resulting in thicker zeolite layer with more inter-crystalline gaps. Consequently, membranes with lower selectivity, along with almost the same permeance, are obtained. The results show that with dual-layer crystals on the hollow fiber support, secondary growth under the conditions (low initial temperatures) favoring nucleation can produce final MFI zeolite membranes with advantageous separation characteristics.

### Membrane Molar Ratio of Si to Al, Hydrophobicity and Separation of Ethanol and Water

Water drop on the MFI zeolite membrane surface exhibits a contact angle larger than 90° and the EDAX spectra for 4 membranes show mainly Si peak with a very small Al peak on the background. Water contact angles and molar ratio of Si to Al for the four MFI zeolite membranes are summarized in Table 4. The contact angle increases with increasing molar ratio of Si to Al. The single-layer seed MFI zeolite membrane has a lower molar ratio of Si to Al and hence less hydrophobic than the double-layer seed MFI zeolite membranes. This confirms that double-layer seed is effective in preventing Al from getting into the zeolite layer. Membrane sample M14 shows highest molar ratio of Si to Al (187) with large contact angle (149°), showing high hydrophobicity. Since the alkalinity of synthesis solution and the calcination temperature in all membrane were kept constant at OH̅/Si=0.45 and 450° C., respectively, the difference in molar ratio of Si to Al among the three double-layer seeded MFI zeolite membranes might be due to different microstructures of the membranes.

TABLE 4
Hydrophobicity (water contact angle and molar
ratio of Si to Al (Si/Al ratio)) and
pervaporation results of MFI-type membranes

| | | | Water |
|---|---|---|---|
| | | Si/Al | contact |
| Synthesis method | Sample | ratio | angle (°) |
| Single-layer seeding | M2 | 41.8 | 106 |
| Constant-temperature + | M10 | 99.0 | 127 |
| Dual-layer seeding | | | |
| Varying-temperature + | M14 | 186.6 | 149 |
| Dual-layer seeding | | | |
| Varying-temperature + | M15 | 105.3 | 133 |
| Dual-layer seeding | | | |

The results in Table 4 show that using a dual-layer seeding method in combination with a varying-temperature profile can effectively avoid transfer of aluminum ions from the support by direct solid-state diffusion and indirect dissolution into the synthesis solution. This is at least in part because the microstructure of the membranes prepared by the dual-layer seeding method includes of a porous region at the bottom of the zeolite layer (in direct contact with the alumina support). The porosity of this bottom-layer leads to lower solid-state direct diffusion of aluminum ions from the support to the zeolite layer during the calcination process. The varying-temperature secondary growth includes a low temperature initial step (125° C.) which minimizes the dissolving of the aluminum from the support into the synthesis solution, keeping the synthesis solution at high molar ratio of Si to Al. The final MFI zeolite membranes are more hydrophobic possibly also due to membranes with minimized intercrystalline gaps, thus substantially reducing hydrophilic crystallite surface Si—OH groups.

Ethanol and water pervaporation separation was performed on seven double-layer seed membranes with higher ideal selectivity between N₂ and SF₆, and, for comparison, a single-layer seed membrane (M2). The results are presented in Table 5. The results show that double-layer membranes have much higher separation factor for ethanol and water, with slightly smaller flux, than the single-layer seed membrane. The pervaporation performance of MFI-type zeolite membranes in organic/water separations mainly depends at least in part on three factors: quality, thickness and hydrophobicity of zeolite layer. With double-layer seed, the MFI zeolite membranes have a higher molar ratio of Si to Al and hence are more hydrophobic and selective between ethanol and water than the single-layer seed membrane. The smaller flux for the double-layer membranes is likely due to slightly larger effective membrane thickness for the double-layer seed membranes as compared to single-seed membranes.

TABLE 5
The effect of dual-layer seeding and varying-
temperature (DLS + VT) hybrid method on
the pervaporation separation performance of
ethanol and water (ethanol/water separation factor)
of hollow fiber MFI zeolite membranes

| | | | Total flux | Ethanol/water |
|---|---|---|---|---|
| Synthesis method | Sample | CSR | (kg m⁻² h⁻¹) | separation factor |
| Single-layer seeding + | M2 | 1 | 8.2 | 2 |
| constant temperature | | | | |
| secondary growth | | | | |
| Dual-layer seeding | M7 | 3.75 | 7.4 | 22 |
| method + constant | M8 | 15 | 6.8 | 46 |
| temperature secondary | M9 | 10 | 4.7 | 66 |
| growth | M10 | 6 | 2.3 | 101 |
| | M11 | 4 | 1.5 | 128 |
| Dual-layer seeding + | M14 | 6 | 2.9 | 160 |
| Varying-temperature | M15 | 6 | 3.9 | 95 |
| secondary growth | | | | |

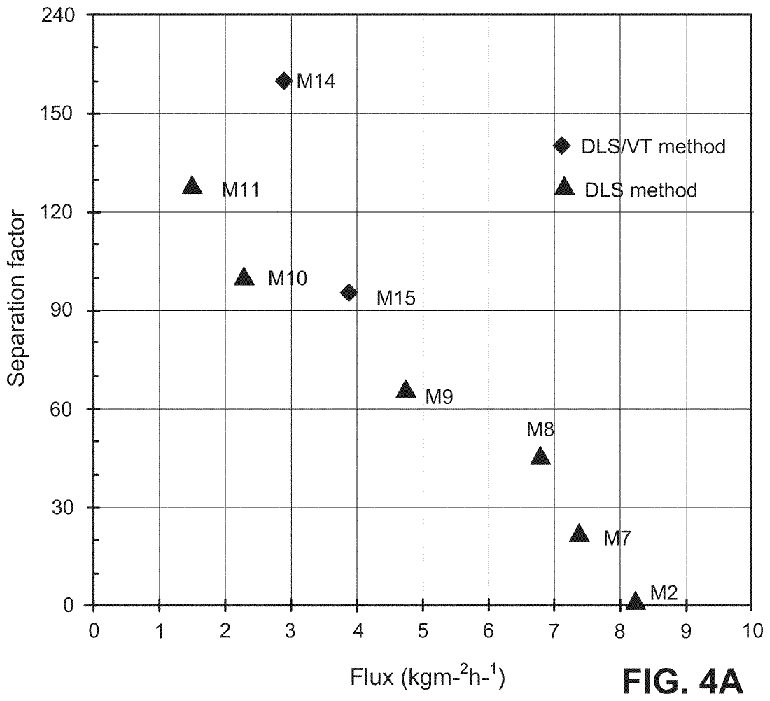

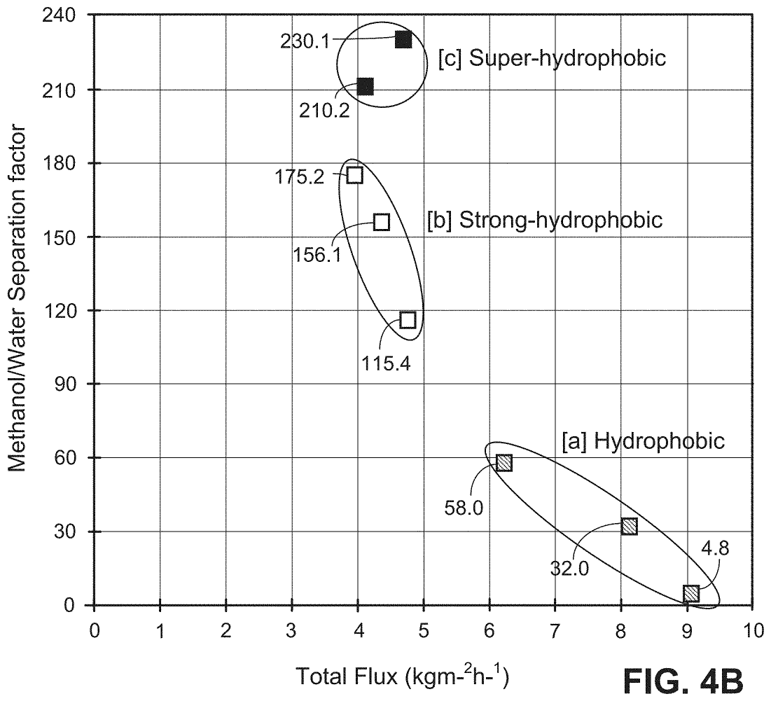

FIG. 4A shows the performance of the separation factor of ethanol and water for membranes prepared as described in this Example. FIG. 4B shows pervaporation separation factor versus the flux of methanol and water for three different groups of membranes. (a) the hydrophobic membranes; synthesized by single layer seed at constant temperature and time, (b) the strong-hydrophobic membranes: synthesized by dual-layer seeding followed by low-to-high varying temperature secondary growth (the total synthesis time was kept constant), and (c) the super-hydrophobic membranes; synthesized by an IMZ layer followed by the secondary growth at the variable temperature/time profile. The high performance of these membranes for alcohol/water separation is due at least in part to the high hydrophobicity of the membranes as a result of the high molar ratio of Si to Al achieved by the method of double-layer seeding with variable temperature secondary growth. In two examples, hollow fiber supported MFI zeolite membranes with a molar ratio of Si to Al of 187 exhibit pervaporation separation factor of 160 with total flux of 3 kg m⁻² h⁻¹ for separation of ethanol and water and pervaporation separation factor of 230 with a total flux of 4.7 kg m⁻² h⁻¹ for separation of methanol and water. Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of fabricating a zeolite membrane on a substrate, the method comprising:
disposing first zeolite crystals on a substrate to yield a first layer on the substrate;
disposing second zeolite crystals on the first layer to yield a second layer on the first layer, thereby yielding a membrane precursor, wherein the second zeolite crystals have a smaller average diameter than the first zeolite crystals;
heating the membrane precursor at a first temperature for a first length of time;
increasing or decreasing the temperature of the membrane precursor from the first temperature to a second temperature, wherein the second temperature exceeds the first temperature or the first temperature exceeds the second temperature, respectively; and
heating the membrane precursor at the second temperature for a second length of time to yield the zeolite membrane.

2. The method of claim 1, wherein the zeolite membrane is an MFI zeolite membrane.

3. The method of claim 1, wherein the substrate comprises a hollow fiber.

4. The method of claim 3, wherein the hollow fiber comprises alumina.

5. The method of claim 1, wherein the zeolite membrane is substantially free of inter-crystalline gaps.

6. The method of claim 1, wherein disposing the second zeolite crystals on the first layer comprises filling gaps between the first zeolite crystals with the second zeolite crystals.

7. The method of claim 1, wherein the first zeolite crystals have an average diameter in a range of 0.5 μm to 2.0 μm.

8. The method of claim 1, wherein the second zeolite crystals have an average diameter in a range of 50 nm to 500 nm.

9. The method of claim 1, wherein the first temperature is in a range of 110° C. to 140° C.

10. The method of claim 1, wherein the second temperature is in a range of 150° C. to 190° C.

11. The method of claim 1, wherein the first length of time is in a range of 1 hour to 10 hours.

12. The method of claim 1, wherein the second length of time is in a range of 1 hour to 10 hours.

13. The method of claim 1, wherein the zeolite is silicalite and the molar ratio of Si to Al exceeds 150.

14. The method of claim 1, wherein the zeolite membrane is hydrophobic.

15. A zeolite membrane comprising:
a substrate;
a first zeolite layer on the substrate; and
a second zeolite layer on the first zeolite layer,
wherein a porosity of the first zeolite layer exceeds a porosity of the second zeolite layer.

16. The zeolite membrane of claim 15, wherein the substrate comprises a hollow fiber.

17. The zeolite membrane of claim 16, wherein the hollow fiber comprises alumina.

18. The zeolite membrane of claim 15, wherein the zeolite comprises silicalite.

19. The zeolite membrane of claim 15, wherein the first zeolite layer comprises first intergrown zeolite crystals, and the second zeolite layer comprises second intergrown zeolite crystals.

20. The zeolite membrane of claim 15, wherein the zeolite membrane is hydrophobic.
